(19) United States
(12) Patent Application Publication
(10) Pub. No.: US 2009/0006528 A1
(43) Pub. Date: Jan. 1, 2009

(54) AVAILABILITY DETERMINATION OF A PARTY TO RECEIVE A CALL PRIOR TO CALL SETUP

(76) Inventors: Ramachendra P. Batni, Phoenix, AZ (US); Ramesh V. Pattabhiraman, New Albany, OH (US); Ajitkumar Rudran, Cary, NC (US); Kumar V. Vemuri, Naperville, IL (US)

Correspondence Address: DUFT BORNSEN & FISHMAN, LLP, 1526 SPRUCE STREET, SUITE 302, BOULDER, CO, 80302, US

(21) Appl. No.: 11/769,366

(22) Filed: Jun. 27, 2007

(51) Int. Cl. G06F 15/16

(52) U.S. Cl. 709/203

(57) ABSTRACT

Presence servers, communication devices, and methods are disclosed for determining the availability of a target party to receive a call prior to call setup. Upon initiation of a call to a target party, the communication device of a subscriber transmits an availability request message to a presence server requesting the availability of the target party to receive the call. Responsive to the availability request message, the presence server determines the availability of the target party to receive the call and transmits an availability response message indicating the availability of the target party to receive the call to the subscriber's communication device. The subscriber's communication device receives the availability response message from the presence server, displays the availability of the target party to receive the call from the subscriber, and may talk other associated actions such as setting up the call to the target party if it is available.

### BACKGROUND OF THE INVENTION

1. Field of the Invention

The invention is related to the field of communication networks and, in particular, to determining the availability of a target party to receive a call prior to setting up the call to the target party.

2. Statement of the Problem

In telecommunications networks, a network presence indicates the status of a party on a communication network, or the communication capabilities of a party for communicating over the communication network. The network presence for a party may include the device or devices of the party, such as a cell phone, a PDA, etc. The network presence may further include services subscribed to or available to the party, such as Instant Messaging (IM), Push-to-Talk over Cellular (PoC), email, etc. The network presence may further include the status of the party, such as mood, location, etc.

To implement a presence service, the target party (also referred to as “presentity”) provides presence information or a presence state via a network connection to a presence server. The presence server then stores a network presence record for the target party that may be distributed to one or more subscribers to the presence service (also referred to as “watchers”). The subscriber(s) is then able to monitor the network presence of the target party to determine how to communicate with the target party.

Assume for example that tie network presence of the target party includes the capability of a phone call. After seeing this communication capability, the subscriber may decide to initiate a call to the target party. However, the target party may be on another call (i.e., busy) and unavailable to receive a call from the subscriber at this time. The presence information typically provided by the presence server only indicates that the target party is capable of phone communications (i.e., presently registered on a communication network), but does not indicate whether the target party is presently available to receive a call. Before a call is placed to the target party, it may be advantageous for the subscriber to know the availability of the target party to receive the call.

There are generally three processes (in known prior art) for determining the availability of a target party to receive a call. For the first process, a presence server triggers on call setup messages and call tear down messages from the target party to determine the availability of the target party, and stores this information in memory. The presence server then transmits an indication of the availability of the target party to any subscriber that has requested to receive such information whenever a change occurs in the call status of the target party.

One problem with this process is that the presence server receives all the call setup messages and call tear down messages in a communication network. In a large network, the presence server may be bombarded with call setup messages and call tear down messages. Further, the presence server transmits an indication of the availability of a target party to all subscribers that are watching the target party. This may be a waste of network resources. As a result, this process does not scale effectively to larger communication networks.

Another process for determining the availability of a target party to receive a call is to have the presence server periodically determine the availability of the target party. For instance, the presence server may periodically query a switching system (e.g., an MSC/VLR) that is serving the target party to determine the availability of the target party. After the availability of a target party is determined, the presence server transmits an indication of the availability of the target party to all subscribers that are watching the target party.

One problem with this process is that there are no triggering events defined in the presence server for determining the availability of the target party on an as-needed basis. The presence server periodically determines the availability of the target party, even if the availability of the target party is not needed at the time. This process may be a waste of network resources.

Another process for determining the availability of a target party to receive a call is a peer to peer approach. Before a call is set up across a communication network from a subscriber to a target party, the subscriber transmits an availability request message over the communication network to the target party or to a switching system that is serving the target party. Responsive to the availability request message, the target party or the switching system transmits an availability response message back to the subscriber indicating the availability of the target party to receive the call.

One problem with this process is that the overhead in determining the availability of the target party is almost equivalent to the actual call setup. Such a process is inefficient.

As illustrated above, the present processes for determining the availability of a target party to receive a call prior to call setup are ineffective.

### SUMMARY OF THE SOLUTION

Embodiments of the invention solve the above and other related problems by having a communication device of subscriber trigger on the initiation of a call to a target party, and having a presence server determine the availability of the target party responsive to the communication device triggering on call initiation. The presence server may then transmit an indication of the availability of the target party to the subscriber's communication device prior to call setup. The subscriber may then see the availability of the target party for receiving the call before call setup is attempted.

In one embodiment, a communication device identifies an initiation of a call to a target party, and transmits an availability request message to a presence server responsive to the call initiation and prior to call setup. The availability request message requests the availability of the target party to receive the call. The presence server receives the availability request message from the subscriber's communication device, and determines the availability of the target party to receive the call. The presence server then generates an availability response message indicating the availability of the target party to receive the call, and transmits the availability response message to the subscriber's communication device prior to call setup. The subscriber's communication device receives the availability response message from the presence server, and displays the availability of the target party to receive the call. The subscriber or the subscriber's communication device may then complete the call to the target party or choose alternative forms of communicating with the target party (e.g., email or IM).

The process of determining the availability of the target party as provided herein is an improvement over present processes. The trigger for determining the availability of a target party is defined in the subscriber's communication device upon call initiation to the target party. The presence server then determines the availability of the target party responsive to the trigger in the subscriber's communication device. This process makes efficient use of the presence server by having the presence server determine the availability of the target party on an as-needed basis when a call is initiated to the target party. This process thus scales effectively to large communication networks.

The invention may include other exemplary embodiments described below.

### DESCRIPTION OF THE DRAWINGS

The same reference number represents the same element or same type of element on all drawings.

FIG. 1 illustrates a communication network in an exemplary embodiment of the invention.

FIG. 2 illustrates a communication device in an exemplary embodiment of the invention.

FIG. 3 is a flow chart illustrating a method of operating a communication device to determine the availability of a target party to receive a call in an exemplary embodiment of the invention.

FIG. 4 is a flow chart illustrating a method of operating a presence server to determine the availability of a target party to receive a call in an exemplary embodiment of the invention.

FIG. 5 illustrates a communication device displaying a contacts list to a subscriber in an exemplary embodiment of the invention.

FIG. 6 illustrates a communication device displaying an indication that a target party is available in an exemplary embodiment of the invention.

FIG. 7 illustrates a communication device displaying options to a subscriber when a target party is unavailable in an exemplary embodiment of the invention.

### DETAILED DESCRIPTION OF THE INVENTION

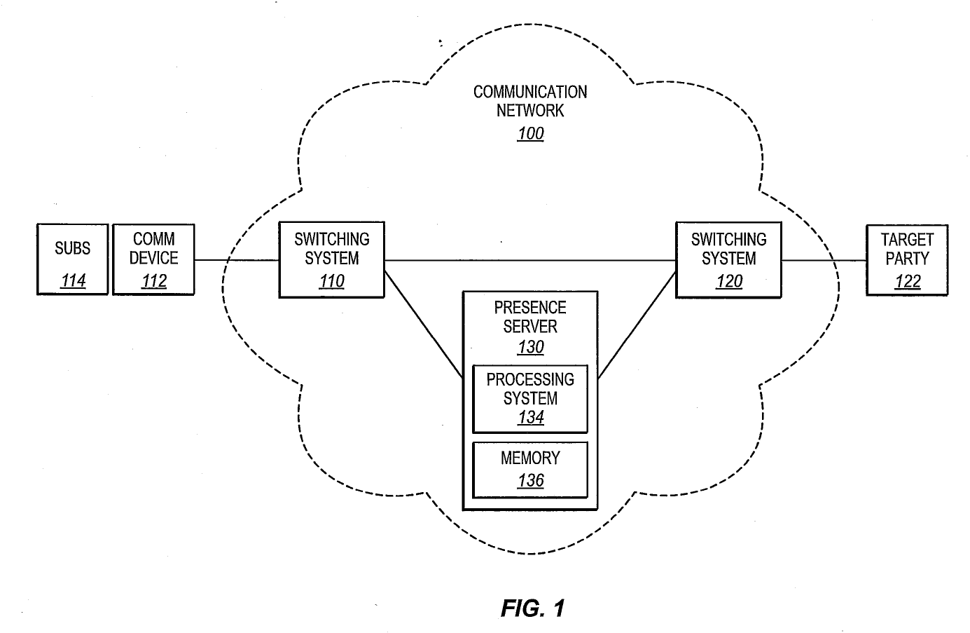

FIGS. 1-7 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 may comprise a cellular network, an IMS network, or another type of network. Communication network 100 includes a switching system 110 adapted to serve a communication device 112 of a subscriber 114. Subscriber 114 has subscribed to a presence service that provides presence information on one or more target parties. For example, subscriber 114 may set up a contacts list in communication device 112, and the presence service may provide presence information for contacts (referred to as target parties) in the contact list. Switching system 110 comprises any server, function, or other system adapted to serve calls or other communications from communication device 112. For example, in a cellular network, such as a CDMA or UMTS network, switching system 110 may comprise a MSC/VLR. In an IMS network, switching system 110 may comprise a Call Session Control Function (CSCF).

Communication network 100 further includes a switching system 120 adapted to serve a target party 122. Switching system 120 comprises any server, function, or other system adapted to serve calls or other communications from target party 122, such as an MSC/VLR, a CSCF, etc. The term “target party” refers to a user and/or one or more communication devices of a user. For instance, target party 122 may represent a user, a cell phone, a PDA, a VoIP phone, a PC, etc. Target party 122 may have the capability of communicating over various media types, such as a phone call, email, text messages, Instant Messages (IM), etc. Target party 122 may have a one or more aliases for communication, such as sip:johndoe@company.com or tel:9195555555.

Although two switching systems are show in FIG. 1, those skilled in the art understand that communication device 112 and target party 122 may be served by the same switching system. Also, although switching system 110 and switching system 120 are shown as part of the same communication network 100, these two systems may be implemented in different networks possibly operated by different service providers. For instance, switching system 110 may be implemented in an IMS network while switching system 120 may be implemented in a CDMA network.

Communication network 100 further includes a presence server 130 having a processing system 134 and a memory 136. Presence server 130 comprises any server, application, database, or system adapted to determine the network presence of target parties 122 and provide presence information to subscribers 114. The network presence for a party may include the device or devices of the party, such as a cell phone, a PDA, etc. The network presence may further include services subscribed to or available to the party, such as Instant Messaging (IM), Push-to-Talk over Cellular (PoC), email, etc. The network presence may further include the status of the party, such as mood, location, etc. In this embodiment, presence server 130 is further adapted to determine the availability of target parties 122 to receive calls prior to call setup as is further described herein.

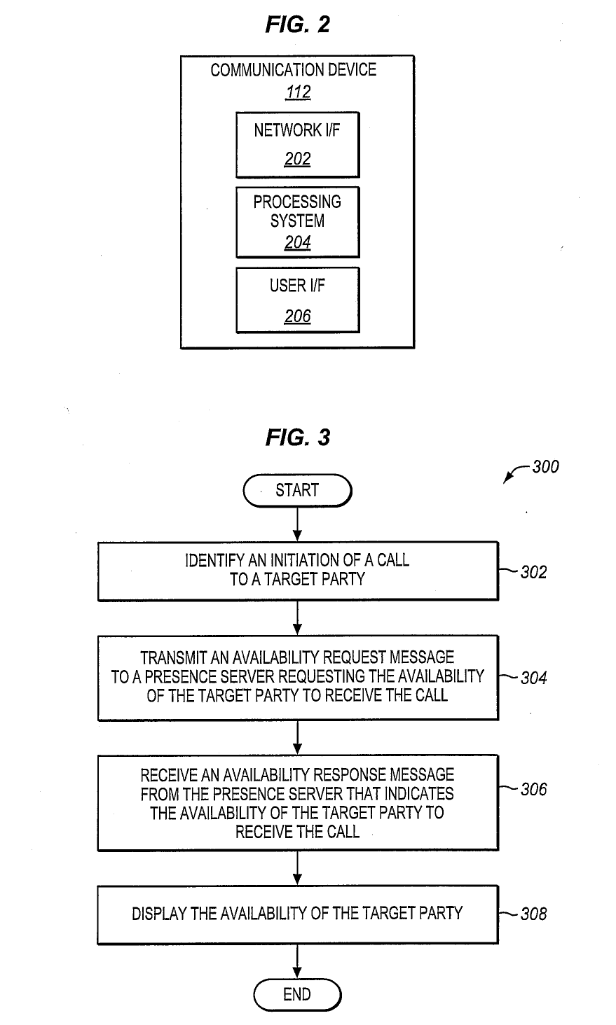

FIG. 2 illustrates a communication device 112 in an exemplary embodiment of the invention. Communication device 112 includes a network interface 202, a processing system 204, and a user interface 206. Network interface 202 comprises any components or systems adapted to communicate with communication network 100. Network interface 202 may comprise a wireline interface or a wireless interface. Processing system 204 comprises a processor or group of inter-operational processors adapted to operate according to a set of instructions. The instructions may be stored on a removable card or chip, such as a SIM card. User interface 206 comprises any components or systems adapted to receive input from a user, such as a keypad, a pointing device, etc, and/or convey content to the user, such as a display, a speaker, etc.

According to the presence service subscribed to by subscriber 114, presence server 130 determines the network presence of target party 122 on communication network 100 (see FIG. 1). For instance, presence server 130 may query switching system 120 or target party 122 to determine the communication capabilities of target party 122, such as phone calls, email, text messages, IMs, etc. Presence server 130 then transmits an indication of the network presence of target party 122 to the communication device 112. Communication device 112 may then display the network presence of target party 122 to subscriber 114. For example, when subscriber 114 accesses a contact list to view target party 122, then communication device 112 may display the network presence of target party 122 to subscriber 114.

Assume that the network presence of target party 122 includes the capability of a phone call. After seeing this communication capability, subscriber 114 may decide to initiate a call to target party 122. For instance, subscriber 114 may select target party 122 out of the contact list, and select a call initiation to target party 122. However, target party 122 may be on another call or session (i.e., busy) and unavailable to receive a call from subscriber 114 at this time. The presence information provided by presence server 130 only indicates that target party 122 is capable of phone communications (i.e., presently registered on communication network 100), but does not indicate whether target party 122 is presently available to receive a call. Before a call is placed to target party 122, it may be advantageous for subscriber 114 to know the availability of target party 122 to receive the call.

FIG. 3 is a flow chart illustrating a method 300 of operating a communication device 112 to determine the availability of a target party 122 to receive a call in an exemplary embodiment of the invention. The steps of method 300 will be described with reference to communication network 100 in FIG. 1 and communication device 112 in FIG. 2. The steps of the flow chart in FIG. 3 are not all inclusive and may include other steps not shown.

In step 302 of method 300, processing system 204 identifies an initiation of a call to target party 122. For instance, processing system 204 may identify that subscriber 114 has selected target party 122 out of the contact list to initiate the call. In step 304, processing system 204 transmits an availability request message to presence server 130 through network interface 202 responsive to the call initiation. The availability request message transmitted by processing system 204 requests the availability of target party 122 to receive the call being initiated by subscriber 114. The availability request message is transmitted to presence server 130 prior to call setup. Processing system 204 may interrupt normal call setup procedures to transmit the availability request message, and halt the transmission of a call setup message to switching system 110. The availability request message may comprise a SIP SUBSCRIBE message or a message of another protocol.

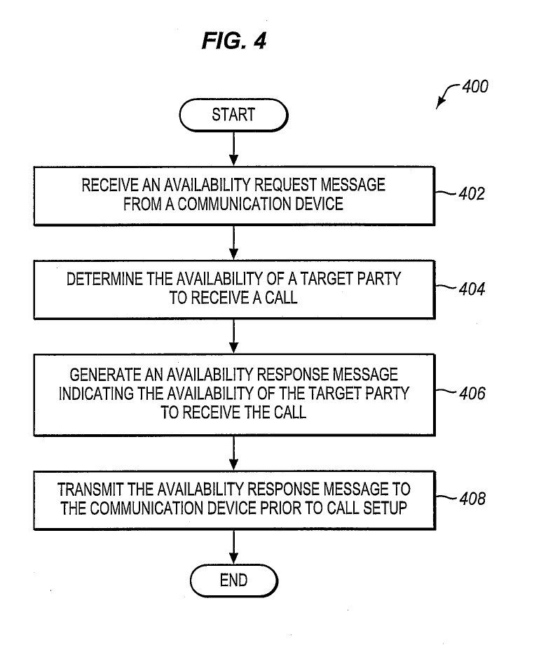

FIG. 4 is a flow chart illustrating a method 400 of operating a presence server 130 to determine the availability of a target party 122 to receive a call in an exemplary embodiment of the invention. The steps of method 400 will be described with reference to communication network 100 in FIG. 1. The steps of the flow chart in FIG. 4 are not all inclusive and may include other steps not shown.

In step 402 of method 400, processing system 134 in presence server 130 receives the availability request message from communication device 112. In step 404, processing system 134 determines the availability of target party 122 to receive the call responsive to receiving the availability request message. For example, processing system 134 may query switching system 120 that is serving target party 122, such as with a Position Request (POSREQ) message, to determine if target party 122 is on another call. Processing system 134 then generates an availability response message indicating the availability of target party 122 to receive the call in step 406. If target party 122 is on another call, then the indication of the availability of target party 122 will indicate that target party is busy. If target party 122 is not on another call, then the indication of the availability of target party 122 will indicate that target party is available. In step 408, processing system 134 transmits the availability response message to communication device 112 prior to call setup. The availability response message may comprise a SIP NOTIFY message that is transmitted responsive to a previously received SIP SUBSCRIBE message.

If target party 122 is determined to be unavailable (i.e., on another call), then processing system 134 may store or cache the availability of target party 122 in memory 136 for a time period. Processing system 134 stores the availability of target party 122 so that it may respond to other subscribers (not shown) that also want to know the availability of target party 122. Processing system 134 may then avoid having to query switching system 120 or target party 122 to determine the availability of target party 122, as this information is stored in memory 136.

Processing system 134 may have pre-defined parameters indicating how long the availability of target party 122 is stored in memory 136. For instance, processing system 134 may store the availability of target party 122 for a default time period related to the average time that a party is on a call, such as one minute, two minutes, three minutes, or some other time period. Processing system 134 may alternatively apply heuristic rules on a call history of target party 122 to determine the time period that the availability of target party 122 is stored in memory 136. For instance, if processing system 134 processes the call history of target party 122 to determine that target party 122 has a call-time average of ten minutes, then processing system 134 may store the availability of target party 122 for ten minutes.

Referring again to method 300 illustrated in FIG. 3, processing system 204 receives the availability response message from presence server 130 through network interface 202 in step 306. The availability response message indicates the availability of target party 122 to receive the call. Processing system 204 then displays the availability of target party 122 to receive the call to subscriber 114 in step 308. Subscriber 114 may then be able to see the availability of target party 122 before the call is set up.

If target party 122 is available to receive the call, then processing system 204 may operate in a variety of ways. For instance, processing system 204 may automatically transmit a call setup message to switching system 110 to initiate the call. Processing system 204 may alternatively display an option to subscriber 114 to set up the call to target party 122. If subscriber 114 selects this option, then processing system 204 transmits a call setup message to switching system 110 to initiate the call.

If target party 122 is not available to receive the call, then processing system 204 may also operate in a variety of ways. For instance, processing system 204 may display other modes of communicating with target party 122 other than a call, such as email, IM, text message, etc. Upon receipt of the availability request message in presence server 130, presence server 130 may determine a status of other modes of communicating with target party 122 in addition to determining the availability of target party 122 to receive a call. Presence server 130 may then further indicate the status of other modes of communicating with target party 122 in the availability response message. Processing system 204 may then display the other modes of communicating with target party 122 along with a status of the other communication modes. Subscriber 114 may then choose to initiate another type of communication to target party 122.

Processing system 204 may alternatively display an option to subscriber 114 to set up the call to target party 122 regardless of the unavailable status of target party 122. If subscriber 114 selects this option, then processing system 204 transmits a call setup message to switching system 110 to initiate the call. Switching system 120 will then receive the call setup message from switching system 110 and invoke a call waiting feature for target party 122, route the call to a voice mail server for target party 122, or perform another function. Processing system 204 may alternatively display an option to subscriber 114 to stop or quit call setup to target party 122. Processing system 204 may alternatively retry the call to target party 122 at a later time. The retry may be responsive to input from subscriber 114. The retry may also be automatic in that processing system 204 sets a retry call timer, and automatically performs a call retry at the expiration of the retry call timer. Processing system 204 may perform other functions responsive to target party 122 being identified as unavailable.

Subscriber 114 may also choose to be notified when target party 122 becomes available to receive a call. Processing system 204 may display an option to be notified when target party 122 becomes available. If subscriber 114 selects this option, then processing system 204 transmits a notification request message to presence server 130. Presence server 130 may then contact switching system 120 or target party 122 requesting to be notified when target party 122 becomes available. Subsequently, if presence server 130 receives a notification from switching system 120 or target party 122 that target party 122 is now available, then presence server 130 transmits a notification response message to communication device 112 indicating that target party 122 is available. Communication device 112 may then set up a call to target party 122.

If presence server 130 stores the availability of target party 122 in memory 136, then it may respond to other availability request messages by determining the availability of the target party 122 as stored in memory 136. However, a subscriber may want to force presence server 130 to actively determine the availability of target party 122 instead of relying on the information stored in memory 136. “Actively determining” means to query one or more network nodes to determine the present status or availability of a party rather than relying on information stored in memory. For example, assume when communication device 112 initiates the call to target party 122 and transmits an availability request message to presence server 130, that presence server 130 has already stored the availability of target party 122 in memory 136. Processing system 134 in presence server 130 may determine the availability of target party 122 as stored in memory 136, and respond to communication device 112 accordingly.

However, subscriber 114 may want to direct or force presence server 130 to actively determine or pull the present availability of target party 122 by querying switching system 120 and/or target party 122. This is in contrast to presence server 130 identifying the availability of the target party 122 as stored in memory 136. To force presence server 130, communication device 112 may insert a flag in the availability request message (e.g., a SIP SUBSCRIBE message) that indicates a forced active determination of the availability of target party 122 to receive a call. Responsive to processing the flag in the availability request message, processing system 134 in presence server 130 transmits a query to switching system 120 and/or target party 122 to determine the availability of target party 122 instead of determine the availability of target party 122 based on information stored in memory 136. Processing system 134 may then respond to communication device 112 accordingly with the availability of target party 122 that was actively determined.

Subscriber 114 may also want to force presence server 130 to actively determine the availability or status of other modes of communication for target party 122, such as the status of IM, email, etc. Subscriber 114 may identify one or more of the other communication modes of target party 122 that he/she wants a forced status check. To do so, communication device 112 may insert one or more flags in the availability request message (e.g., a SIP SUBSCRIBE message) that indicates a forced active determination of the availability or status of one or more of the other communication modes of target party 122. If communication device 112 inserts one or more flags in the availability request message, then processing system 134 in presence server 130 has to do one or more pulls of the present status of the other communication modes indicated by the flags. Processing system 134 may then respond to communication device 112 accordingly with the statuses of the other communication modes that were actively determined.

As an example of the above concept, assume that subscriber 114 has subscribed to a service to receive a voice call status (e.g., busy or idle) of target party 122 and has subscribed to a service to receive IM session status (e.g., not in an IM session or involved in one or more IM sessions) of target party 122. In this case, subscriber 114 may operate communication device 112 to set the forced flags for none, one, or both of these services. Assuming that subscriber 114 instructs communication device 112 to set the forced flag for both the services in the availability request message, processing system 134 in presence server 130 will have to first pull the present information of target party 122 for each of these services (e.g., by querying the appropriate network elements such as by using a POSREQ for the voice call status, and analogously for the IM session status). Processing system 134 then responds to communication device 112 with the present status information of these services.

The above methods of determining the availability of target party 122 as provided herein are improvements over present processes. The trigger for determining the availability of target party 122 is defined in the subscriber's communication device 112 upon call initiation to target party 122. Presence server 130 then determines the availability of target party 122 responsive to the trigger in the subscriber's communication device 112. This process makes efficient use of presence server 130 by having presence server 130 determine the availability of target party 122 on an as-needed basis when a call is initiated to target party 122. This process thus scales effectively to large communication networks.

### EXAMPLE

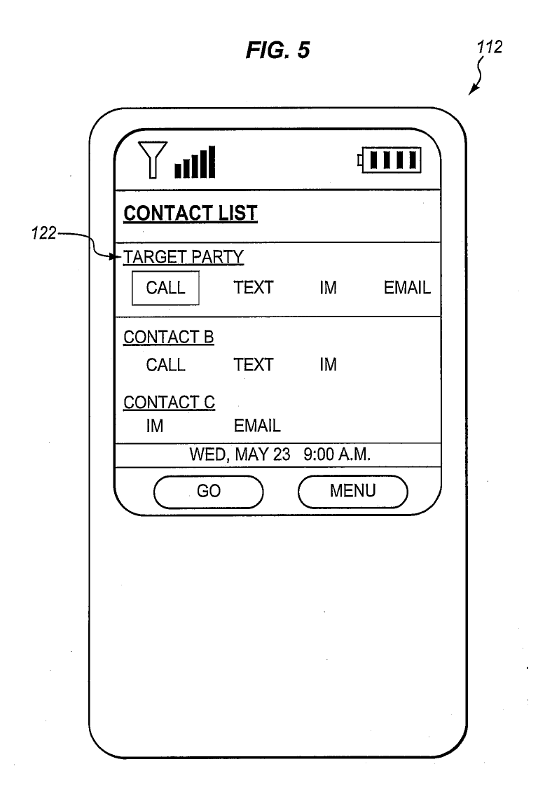

FIGS. 5-7 illustrate an example of determining the availability of target party 122 prior to call setup. FIG. 5 illustrates communication device 112 displaying a contacts list to subscriber 114 in an exemplary embodiment of the invention. The contact list includes target party 122 as shown in FIG. 1 along with other contacts B and C that subscriber 114 has programmed into communication device 112. Because subscriber 114 has subscribed to a presence service, communication device 112 receives presence information for each of the contacts in the contact list from presence server 130. The network presence of target party 122 indicates that target party 122 has the capability of receiving calls, text messages, IM, and email. The network presence of contact B indicates that contact B has the capability of receiving calls, text messages, and IM. The network presence of contact C indicates that contact C has the capability of receiving IM and email.

Assume that subscriber 114 has selected target party 122 in the contact list for communication. Also assume that subscriber 114 has selected to communicate with target party 122 by initiating a phone call. According to the embodiments provided herein, the availability of target party 122 to receive the call as initiated by subscriber 114 is determined prior to the call being setup.

Responsive to identifying initiation of the call, communication device 112 transmits an availability request message to presence server 130 (see also FIG. 1). The availability request message may comprise a SIP SUBSCRIBE message, which indicates to presence server 130 that communication device 112 wants to be informed of updates to information on the availability of target party 122.

Responsive to receiving the availability request message from communication device 112, presence server 130 determines the availability of target party 122 to receive the call. Presence server 130 may query target party 122 or switching system 120 that is serving target party 122 to determine if target party 122 is on another call. Alternatively, presence server 130 may have already determined the availability of target party 122 and stored the availability information in memory 136. Presence server 130 may thus avoid querying target party 122 or switching system 120. Presence server 130 then generates an availability response message that includes an indication of the availability of target party 122, and transmits the availability response message to communication device 112 prior to call setup. If target party 122 is on another call, then the indication of the availability of target party 122 will indicate that target party is busy. If target party 122 is not on another call, then the indication of the availability of target party 122 will indicate that target party 122 is available. The availability response message may comprise a SIP NOTIFY message that is transmitted responsive to a previously received SIP SUBSCRIBE message.

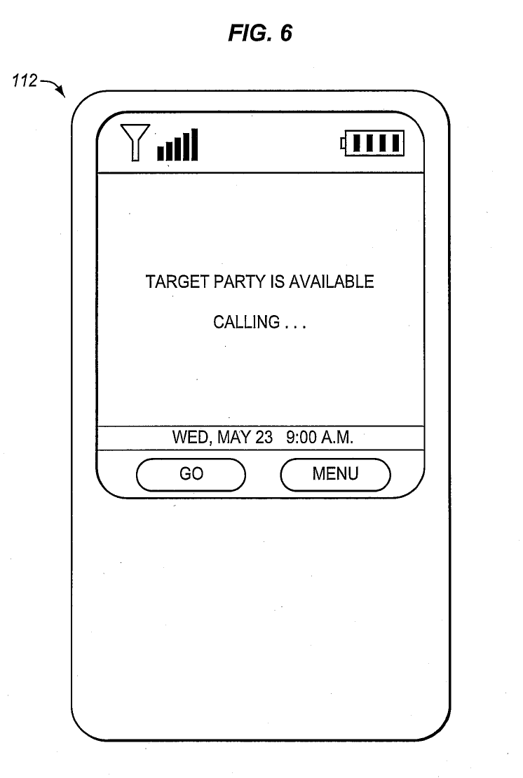

Upon receipt of the availability response message, communication device 112 processes the availability indication in the message. If target party 122 is available, then communication device 112 displays an indication to subscriber 114 that target party 122 is available. FIG. 6 illustrates communication device 112 displaying an indication that target party 122 is available in an exemplary embodiment of the invention. Communication device 112 also automatically transmits a call setup message to switching system 110 to set up the call to target party 122.

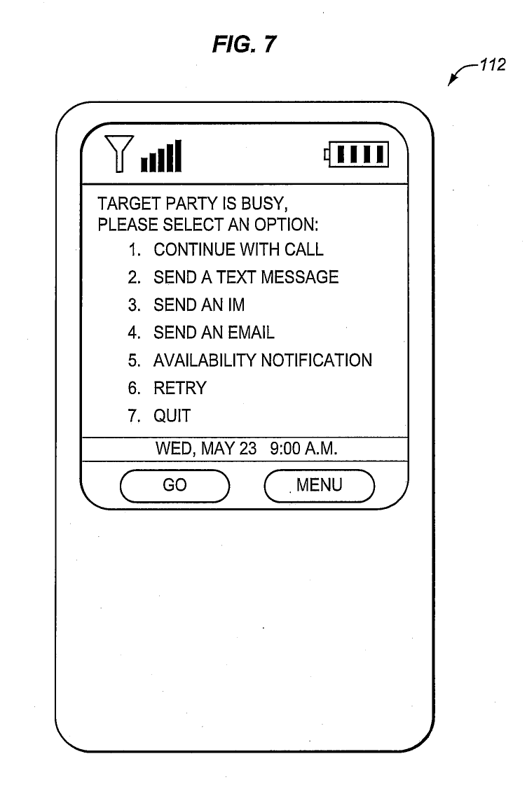

If target party 122 is not available, then communication device 112 displays options to subscriber 114 for proceeding. FIG. 7 illustrates communication device 112 displaying options to subscriber 114 when target party 122 is unavailable in an exemplary embodiment of the invention. One option is to set up the call to target party 122 regardless of the unavailable status of target party 122, such as to get the call waiting feature for target party 122 or voice mail for target party 122. If subscriber 114 selects this option, then communication device 112 transmits a call setup message to switching system 110 to set up the call to target party 122. Other options are to communicate with target party 122 through other modes of communication, such as text message, IM, and email.

Another option is to be notified when target party 122 becomes available. If subscriber 114 selects this option, then processing system 204 transmits a notification request message to presence server 130 to be notified when target party 122 becomes available. Presence server 130 may then contact switching system 120 or target party 122 requesting to be notified when target party 122 becomes available, such as by transmitting a SIP SUBSCRIBE message. When target party 122 subsequently becomes available, switching system 120 or target party 122 notifies presence server 130, such as with a SIP NOTIFY message. If presence server 130 receives a notification from switching system 120 or target party 122 that target party 122 is now available, then presence server 130 transmits a notification response message to communication device 112 indicating that target party 122 is available. Communication device 112 may then set up a call to target party 122.

Another option is to retry the call to target party 122. If subscriber 114 selects this option, then processing system 204 may initiate another call to target party 122. Before a call is placed to target party 122, the availability of target party 122 is determined as described above. Alternatively, if subscriber 114 selects this option, then processing system 204 may set a retry call timer. The retry timer may be set based on a default time period related to the average time that a party is on a call, such as one minute, two minutes, three minutes, or some other time period. Processing system 204 may alternatively apply heuristic rules on a call history of target party 122 to determine the time period for the retry timer. At the expiration of the retry timer, processing system 204 automatically performs a call retry to target party 122.

Another option is to quit the present attempt to communicate with target party 122. Those skilled in the art understand that communication device 112 may provide other options to subscriber 114 in other embodiments.

Although specific embodiments were described herein, the scope of the invention is not limited to those specific embodiments. The scope of the invention is defined by the following claims and any equivalents thereof.

We claim:

1. A method of operating a communication device of a subscriber to determine the availability of a target party to receive a call prior to call setup, the method comprising:
identifying an initiation of a call to a target party;
transmitting an availability request message to a presence server responsive to the call initiation and prior to call setup wherein the availability request message requests the availability of the target party to receive the call;
receiving an availability response message from the presence server indicating the availability of the target party to receive the call; and
displaying the availability of the target party to receive the call.

2. The method of claim 1 wherein if the target party is available to receive the call, then the method further comprises:
transmitting a call setup message to a communication network serving the target party to initiate the call.

3. The method of claim 1 wherein if the target party is not available to receive the call, then the method further comprises:
displaying other modes of communicating with the target party other than a call.

4. The method of claim 1 wherein prior to identifying the initiation of the call, the method farther comprises:
receiving an indication of a network presence of the target party from the presence server; and
displaying the network presence of the target party.

5. The method of claim 1 further comprising:
inserting at least one flag in the availability request message to force the presence server to actively determine at least one of the availability of the target party to receive the call and the status of other modes of communicating with the target party.

6. A communication device adapted to determine the availability of a target party to receive a call prior to call setup, the communication device comprising:
a network interface adapted to communicate with a presence server over a communication network;
a user interface adapted to display information to a subscriber operating the communication device; and
a processing system adapted to identify an initiation of a call to a target party, to transmit an availability request message to the presence server through the network interface responsive to the call initiation and prior to call setup wherein the availability request message requests the availability of the target party to receive the call, to receive an availability response message from the presence server through the network interface indicating the availability of the target party to receive the call, and to display the availability of the target party to receive the call through the user interface.

7. The communication device of claim 6 wherein if the target party is available to receive the call, then the processing system is further adapted to:
transmit a call setup message through the network interface to the communication network serving the target party to initiate the call.

8. The communication device of claim 6 wherein if the target party is not available to receive the call, then the processing system is further adapted to:
display other modes of communicating with the target party other than a call through the user interface.

9. The communication device of claim 6 wherein prior to identifying the initiation of the call, the processing system is further adapted to:
receive an indication of a network presence of the target party from the presence server through the network interface; and
display the network presence of the target party through the user interface.

10. The communication device of claim 6 wherein the processing system is further adapted to:
insert at least one flag in the availability request message to force the presence server to actively determine at least one of the availability of the target party to receive the call and the status of other modes of communicating with the target party.

11. A method of operating a presence server to determine the availability of a target party to receive a call prior to call setup, the method comprising:
receiving an availability request message from a communication device of a subscriber responsive to the communication device identifying an initiation of a call to a target party;
determining the availability of the target party to receive the call responsive to receiving the availability request message;
generating an availability response message indicating the availability of the target party to receive the call; and
transmitting the availability response message to the communication device prior to call setup.

12. The method of claim 11 further comprising:
storing the availability of the target party in a memory for a time period if the target party is determined to be unavailable.

13. The method of claim 12 further comprising:
applying heuristic rules on a call history of the target party to determine the time period that the availability of the target party is stored in the memory.

14. The method of claim 11 wherein prior to receiving the availability request message, the method further comprises:
determining a network presence of the target party; and
transmitting an indication of the network presence of the target party to the communication device.

15. The method of claim 11 wherein determining the availability of the target party to receive the call responsive to receiving the availability request message comprises:
querying at least one of the target party or a switching system that is serving the target party to determine if the target party is on another call.

16. The method of claim 11 wherein determining the availability of the target party to receive the call responsive to receiving the availability request message comprises:
determining the availability of the target party to receive the call as stored in the memory.

17. The method of claim 11 further comprising:
determining a status of other modes of communicating with the target party responsive to receiving the availability request message; and
generating the availability response message to further indicate the status of other modes of communicating with the target party.

18. The method of claim 17 wherein determining the availability of the target party to receive the call responsive to receiving the availability request message comprises:
processing at least one flag in the availability request message indicating a forced active determination of at least one of the availability of the target party to receive the call and the status of other modes of communicating with the target party; and
actively determining at least one of the availability of the target party to receive the call and the status of other modes of communicating with the target party responsive to processing the at least one flag in the availability request message.

19. A presence server adapted to determine the availability of a target party to receive a call prior to call setup, the presence server comprising:
a memory; and
a processing system adapted to receive an availability request message from a communication device of a subscriber responsive to the communication device identifying an initiation of a call to a target party, to determine the availability of the target party to receive the call responsive to receiving the availability request message, to generate an availability response message indicating the availability of the target party to receive the call, and to transmit the availability response message to the communication device prior to call setup.

20. The presence server of claim 19 wherein the processing system is further adapted to:
store the availability of the target party in the memory for a time period if the target party is determined to be unavailable.

21. The presence server of claim 20 wherein the processing system is further adapted to:
apply heuristic rules on a call history of the target party to determine the time period that the availability of the target party is stored in the memory.

22. The presence server of claim 19 wherein prior to receiving the availability request message, the processing system is further adapted to:
determine a network presence of the target party; and
transmit an indication of the network presence of the target party to the communication device.

23. The presence server of claim 19 wherein the processing system is further adapted to:
query a switching system that is serving the target party and/or the target party to determine if the target party is on another call.

24. The presence server of claim 19 wherein the processing system is further adapted to:
determine the availability of the target party to receive the call as stored in the memory.

25. The presence server of claim 19 wherein the processing system is further adapted to:
determine a status of other modes of communicating with the target party responsive to receiving the availability request message; and
generate the availability response message to further indicate the status of other modes of communicating with the target party.

26. The presence server of claim 25 wherein the processing system is further adapted to:
process at least one flag in the availability request message indicating a forced active determination of at least one of the availability of the target party to receive the call and the status of other modes of communicating with the target party; and
actively determine at least one of the availability of the target party to receive the call and the status of other modes of communicating with the target party responsive to processing the at least one flag in the availability request message.
